(19) United States
(12) Patent Application Publication
(10) Pub. No.: US 2011/0225120 A1
(43) Pub. Date: Sep. 15, 2011

(54) SYSTEM FOR MAINTAINING A DISTRIBUTED DATABASE USING LEASES

(75) Inventors: Brian F. Cooper, San Jose, CA (US); Sudarshan V. Kadambi, Sunnyvale, CA (US)

(73) Assignee: Yahoo! Inc., Sunnyvale, CA (US)

(21) Appl. No.: 12/722,093

(22) Filed: Mar. 11, 2010

(51) Int. Cl. G06F 17/30

(52) U.S. Cl. 707/610; 707/E17.005

(57) ABSTRACT

A system and method for maintaining a database with a plurality of replicas that are geographically distributed. A plurality of tables are stored in a first replica, each table including a plurality of records. The system identifying if the record is a stub and requesting a lease from a second replica designated as master for the record if the record is a stub. The system receiving a copy of the record from the second replica and storing data fields of the record in the first replica after receiving the lease.

### SUMMARY

A system and method is provided for maintaining a database with a plurality of replicas that are geographically distributed. A plurality of tables are stored in a first replica, each table including a plurality of records. The system identifying if the record is a stub and requesting a lease from a second replica designated as master for the record if the record is a stub. The system receiving a copy of the record from the second replica and storing data fields of the record in the first replica after receiving the lease.

Further objects, aspects of this application will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a system for maintaining a distributed database;

FIG. 2 is a schematic view of a data farm illustrating exemplary server, storage unit, table and record structures;

FIG. 3 is a schematic view of a process for retrieving data from the distributed system;

FIG. 4 is a schematic view of a process for acquiring a lease;

FIG. 5 is a schematic view of a process for renewing a lease and a process for surrendering a lease;

FIG. 6 is a schematic view of a constraint tree;

FIG. 7 is a flow chart illustrating a method for constraint enforcement for inserts;

FIG. 8 is a flow chart illustrating a method for constraint enforcement for updates;

FIG. 9 is a schematic view of a process for storing data in the distributed system in a master region;

FIG. 10 is a schematic view of a process for storing data in the distributed system in a non-master region; and

FIG. 11 is a schematic view of a computer system for implementing the methods described herein.

### DETAILED DESCRIPTION

Sherpa is a large-scale distributed datastore powering web applications at Yahoo. As in any relational database, the data is organized in tables. Sherpa consists of geographically distributed replicas, with each replica containing a complete copy of all data tables. This scheme is called Full Replication.

A single Sherpa replica is designated the table master. When a new record gets inserted, it first gets inserted at the table master. An asynchronous publish-subscribe message queue, henceforth called the message broker, is used for replicating the insert to all other replicas. The message broker provides for ordered and guaranteed delivery of messages between replicas. Over time, as the record gets accessed from different replicas, the replica from where it is accessed the most is designated as the record master. When a record gets updated, the update gets forwarded to the record master, where it gets applied and then propagated to the other replicas. The record master serves as the arbitrator in deciding the timeline order of the writes.

These days, many systems have a global footprint in terms of distribution of its users. To keep query latencies low, data centers have been located close to the markets which are served. Having complete copies of tables in every replica is an easy way to keep query latencies low, as reads can be serviced locally. However, not all records get accessed from every replica. As such, records can be purged from replicas where they are not needed, given that certain fault tolerance requirements are met.

Selective Replication is useful to reduce the cost of storing a record at a replica. If a replica X holds a copy of a record, writes to that record at any other replica need to be propagated to X. Propagating the writes can consume network bandwidth. If replica X does not hold a copy of the record and there is a subsequent read for it, the read needs to get forwarded to some other replica that does have the record. In addition, the query latencies go up due to the extra network hop. However, the disk storage and bandwidth capacities needed at the replica are now reduced. In addition, many countries have policies on user data storage and export. To conform to these legal requirements, applications need to be able to provide guidelines to the datastore about the replicas in which data can and cannot be stored.

The system may use an asynchronous replication protocol. As such, updates can commit locally in one replica, and are then asynchronously copied to other replicas. Even in this scenario, the system may enforce a weak consistency. For example, updates to individual database records must have a consistent global order, though no guarantees are made about transactions which touch multiple records. It is not acceptable in many applications if writes to the same record in different replicas, applied in different orders, cause the data in those replicas to become inconsistent.

Further, the system may use a master/slave scheme, where all updates are applied to the master (which serializes them) before being disseminated over time to other replicas. One issue revolves around the granularity of mastership that is assigned to the data. The system may not be able to efficiently maintain an entire replica of the master, since any update in a non-master region would be sent to the master region before committing, incurring high latency. Systems may group records into blocks, which form the basic storage units, and assign mastership on a block-by-block basis. However, this approach incurs high latency as well. In a given block, there will be many records, some of which represent users on the east coast of the U.S., some of which represent users on the west coast, some of which represent users in Europe, and so on. If the system designates the west coast copy of the block as the master, west coast updates will be fast but updates from all other regions may be slow. The system may group geographically “nearby” records into blocks, but it is difficult to predict in advance which records will be written in which region, and the distribution might change over time. Moreover, administrators may prefer another method of grouping records into blocks, for example ordering or hashing by primary key.

In one embodiment, the system may assign master status to individual records, and use a reliable publish-subscribe (pub/sub) middleware to efficiently propagate updates from the master in one region to slaves in other regions. Thus, a given block that is replicated to three datacenters A, B, and C can contain some records whose master datacenter is A, some records whose master is B, and some records whose master is C. Writes in the master region for a given record are fast, since they can commit once received by a local pub/sub broker, although writes in the non-master region still incur high latency. However, for an individual record, most writes tend to come from a single region (though this is not true at a block or database level.) For example, in some user databases most interactions with a west coast user are handled by a datacenter on the west coast. Occasionally other datacenters will write that user's record, for example if the user travels to Europe or uses a web service that has only been deployed on the east coast. The per-record master approach makes the common case (writes to a record in the master region) fast, while making the rare case (writes to a record from multiple regions) correct in terms of the weak consistency described above.

However, given that many records are not accessed in each replica, having a full copy of the record at each replica can waste resources. Records only need to be stored at replicas from where they get accessed. Selective Replication is a scheme where each replica contains only a subset of records from the table.

In replicas where the records are not often accessed, a stub of the record can be saved. A stub can include header fields identifying where to access the full record, but may not include the data fields for that record. Then, if a read request is received, the data fields of the record can be accessed from another replica. Since usage patterns are dynamic, if the record is accessed locally the retrieved copy can be stored locally. To coordinate the local storage of records the local replica can request a lease from the replica that is master for the record. A lease can provide permission to store a copy of the record from replica that is record master.

There are multiple reasons why a Selective Replication scheme would be attractive. Notably, to reduce network bandwidth usage, satisfy legal terms of service regarding user data storage and export, and deploy Sherpa replicas in regions where data centers have limited storage and disk bandwidth.

One way of implementing Selective Replication is using constraints that are specified by the application and enforced by the datastore. Constraints include an optional predicate and a set of properties, which together define the replication semantics for the records that match the given predicate. If the predicate is absent, the constraint is assumed to apply to all the records of the given table. The constraint behavior is defined by setting certain properties, which can include:
MIN COPIES: The minimum number of copies of the record to keep around to satisfy the application's fault tolerance requirements.
INCL_LIST: A comma-separated list of replicas at which a copy of the record has to be kept.
EXCL_LIST: A comma-separated list of replicas where a copy of the record should not be kept.

Selective Replication through constraint enforcement helps guarantee a minimum degree of fault tolerance and provides the application fine-grained control over where records can and cannot reside. However, a one drawback of this scheme is that it is not fully adaptive. Constraints may be static, while record access patterns are dynamic.

In addition, experiments have shown that for a constraint-based replication scheme to perform well, the application developer who is defining the constraints must have a good sense of where traffic is coming from. The developer should be aware of what records get accessed from each replica and define constraints such that a record is stored at a replica from where it is accessed frequently. This requires more due diligence on part of the application developer.

Hence, this motivates a need for policies and mechanisms that allow the datastore to automatically make replication decisions based on how records get read or written.

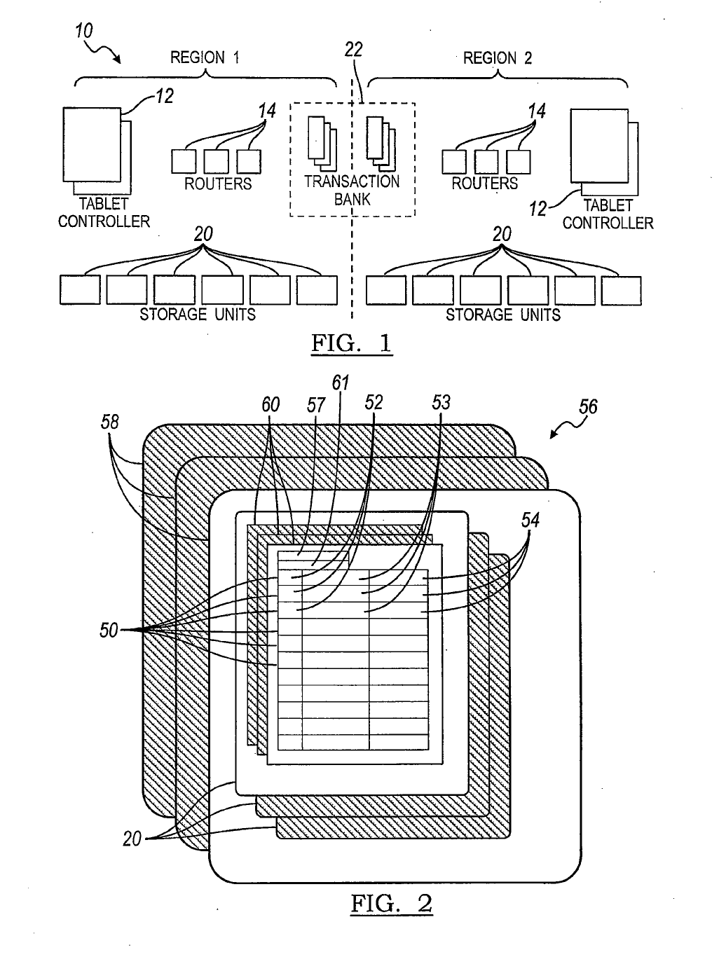

Referring now to FIG. 1, a system embodying the principles of the present application is illustrated therein and designated at 10. The system 10 may include multiple datacenters that are disbursed geographically across the country or any other geographic region. For illustrative purposes two datacenters are provided in FIG. 1, namely Region 1 and Region 2. However, multiple other regions can be provided. Each region may be a scalable duplicate of each other. Each region includes a tablet controller 12, router 14, storage units 20, and a transaction bank 22.

In one example implementation, the system 10 utilizes a hashtable. However, it is understood that other techniques may be used, for example, ordered tables, object oriented databases, tree structured tables. Accordingly, the system 10 provides a hashtable abstraction, implemented by partitioning data over multiple servers and replicating it to multiple geographic regions. An exemplary structure is shown in FIG. 2. Each record 50 is identified by a key 52, contains header fields 53 including various meta-data, and can contain arbitrary data fields 54. A farm 56 is a cluster of system servers 58 in one region that contain a full replica of a database. Note that while the system 10 can include a “distributed hash table” in the most general sense (since it is a hash table distributed over many servers) it should not be confused with peer-to-peer DHTs, since the system 10 (FIG. 1) has many centralized aspects; for example, message routing is done by specialized routers 14, not the storage units 20 themselves.

The basic storage unit of the system 10 is the tablet 60. A tablet 60 contains multiple records 50 (typically thousands or tens of thousands). However, unlike tables of other systems (which clusters records in order by primary key), the system 10 hashes a record's key 52 to determine its tablet 60. The hash table abstraction provides fast lookup and update via the hash function and good load-balancing properties across tablets 60. The hashtable or general table may include table header information 57 stored in a tablet 60 indicating, for example, a datacenter designated as the master replica table and constraint properties for the records in the table. The tablet 60 may also include tablet header information 61 indicating, for example, the master datacenter for that tablet and constraint properties for the records in the tablet.

The system 10 can offer fundamental operations such as: put, get, remove and scan. The put, get and remove operations can apply to whole records, or individual attributes of record data. The scan operation provides a way to retrieve the entire contents of the tablet 60, with no ordering guarantees.

The storage units 20 are responsible for storing and serving multiple tablets 60. Typically a storage unit 20 will manage hundreds or even thousands of tablets 60, which allows the system 10 to move individual tablets 60 between servers 58 to achieve fine-grained load balancing. The storage unit 20 implements the basic application programming interface (API) of the system 10 (put, get, remove and scan), as well as another operation: snapshot-tablet. The snapshot-tablet operation produces a consistent snapshot of a tablet 60 that can be transferred to another storage unit 20. The snapshot-tablet operation is used to copy tablets 60 between storage units 20 for load balancing. Similarly, after a failure, a storage unit 20 can recover lost data by copying tablets 60 from replicas in a remote region.

The assignment of the tablets 60 to the storage units 20 is managed by the tablet controller 12. The tablet controller 12 can assign any tablet 60 to any storage unit 20, and change the assignment at will, which allows the tablet controller 12 to move tablets 60 as necessary for load balancing. However, note that this “direct mapping” approach does not preclude the system 10 from using a function-based mapping such as consistent hashing, since the tablet controller 12 can populate the mapping using alternative algorithms if desired. To prevent the tablet controller 12 from being a single point of failure, the tablet controller 12 may be implemented using paired active servers.

In order for a client to read or write a record, the client must locate the storage unit 20 holding the appropriate tablet 60. The tablet controller 12 knows which storage unit 20 holds which tablet 60. In addition, clients do not have to know about the tablets 60 or maintain information about tablet locations, since the abstraction presented by the system API deals with the records 50 and generally hides the details of the tablets 60. Therefore, the tablet to storage unit mapping is cached in a number of routers 14, which serve as a layer of indirection between clients and storage units 20. As such, the tablet controller 12 is not a bottleneck during data access. The routers 14 may be application-level components, rather than IP-level routers.

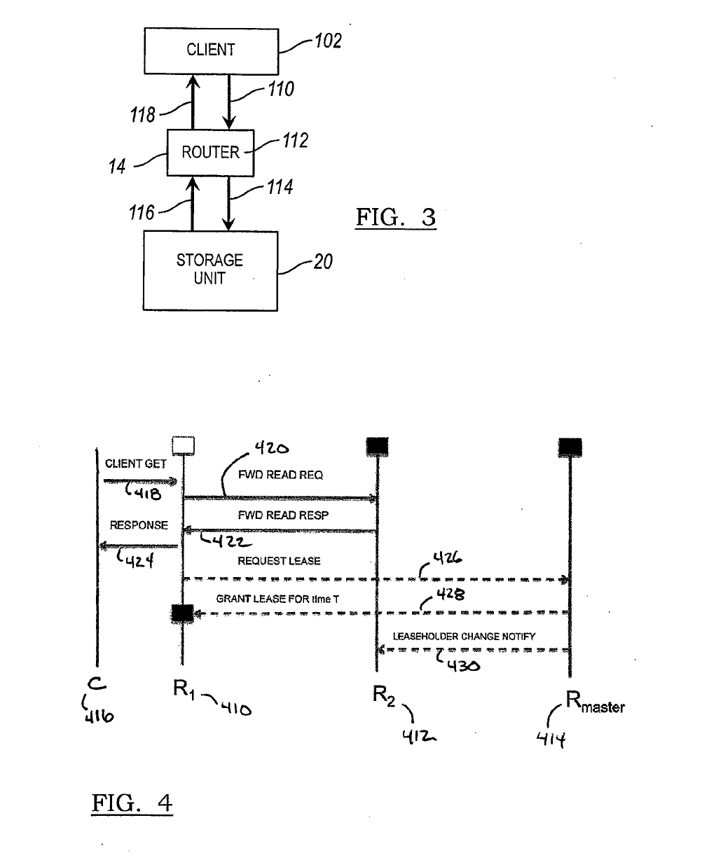

As shown in FIG. 3, a client 102 contacts any local router 14 to initiate database reads or writes. The client 102 requests a record 50 from the router 14, as denoted by line 110. The router 14 will apply the hash function to the record's key 52 to determine the appropriate tablet identifier (“id”), and look the tablet id up in its cached mapping to determine the storage unit 20 currently holding the tablet 60, as denoted by reference numeral 112. The router 14 then forwards the request to the storage unit 20, as denoted by line 114. The storage unit 20 then executes the request. In the case of a get operation, the storage unit 20 returns the data to the router 14, as denoted by line 116. The router 114 then forwards the data to the client as denoted by line 118. In the case of a put, the storage unit 20 initiates a write consistency protocol, which is described in more detail later.

In other scenarios, the client may request a record from a replica that only has a stub. In this scenario the record will be requested from another replica. To facilitate a change in access patterns, the replica may request a lease from the master of the record. Many methods may be used to implement leases.

These methods can be broadly classified based on the level of access statistics that need to be collected. Methods that require no access statistics include caching and lease-based selective replication. One method requires some access to statistics, but only at an aggregate level. This is lease-based selective replication where lease acquisition is triggered based on aggregate statistics. Alternative methods may use record-level access statistics. For example, adaptive replication may track the ratio of local reads to global updates for all records at each replica.

One example of a replication scheme based on caching works as outlined below. Replica R1 has a stub for record K instead of a full replica of the data. A stub is metadata indicating who the record master is and what replicas contain a copy of the record.
R1 gets a read for record K.
R1 looks up the stub for record K and finds out that replica R2 is in the replica list of the record.
R1 makes a forwarded read request to R2 and gets hold of a copy of record K.
R1 does not write K to disk. It is kept in an in-memory cache.
Since it is not an official copy, the replica list not updated at the record master and R1 does not see any of the updates over the message broker. After a while, the record will get purged from the cache on its own due to accesses for other records.
There could also be cache logic to set a bound on how stale the cached data is allowed to get.

This technique has a low footprint for creating a copy of the record. As such, there is no need to update the replica list at the record master and no explicit communication is needed between record master and other replicas for replica addition and removal.

Since R1 does not see any of the updates, reads at R1 could get stale data. Further, it is possible that a replica that is high traffic with respect to a given record is the one that ends up with a stale copy of it, just because it was not among the initial set of replicas chosen by the constraints scheme. Since R1 only has an in-memory copy, it does not count towards the number of copies that are needed to satisfy fault-tolerance constraints (MIN_COPIES).

One method for lease acquisition is provided in FIG. 4. Replica R1 410 has only a stub for record K, while replica R2 412 has a full record. Replica Rmaster 414 is the record master. R1 410 gets a read request for record K from client C 416 as denoted by line 418. R1 410 makes a forwarded read request to R2 412 as denoted by line 420. R2 412 could be any replica that has the record K, not just the record master. R2 412 replies to R1 410 with the record as denoted by line 422. Once R1 410 returns the record to the client 416 as denoted by line 424, R1 410 sends a message over the broker to the record master 414, requesting a lease on the record K, as denoted by line 426. The record master 414 checks if any constraints will be violated if R1 410 gets a copy of the record (like R1 being in the EXCL_LIST) and if not, the record master 414 grants the lease by sending a copy of the record K to R1 410 as denoted by line 428. The record master 414 also adds R1 410 to the list of replicas for that record and publishes a stub message notifying other replicas of this leaseholder change as denoted by line 430. As long as R1 410 holds the lease on the record, reads are serviced locally and updates received over the broker get applied.

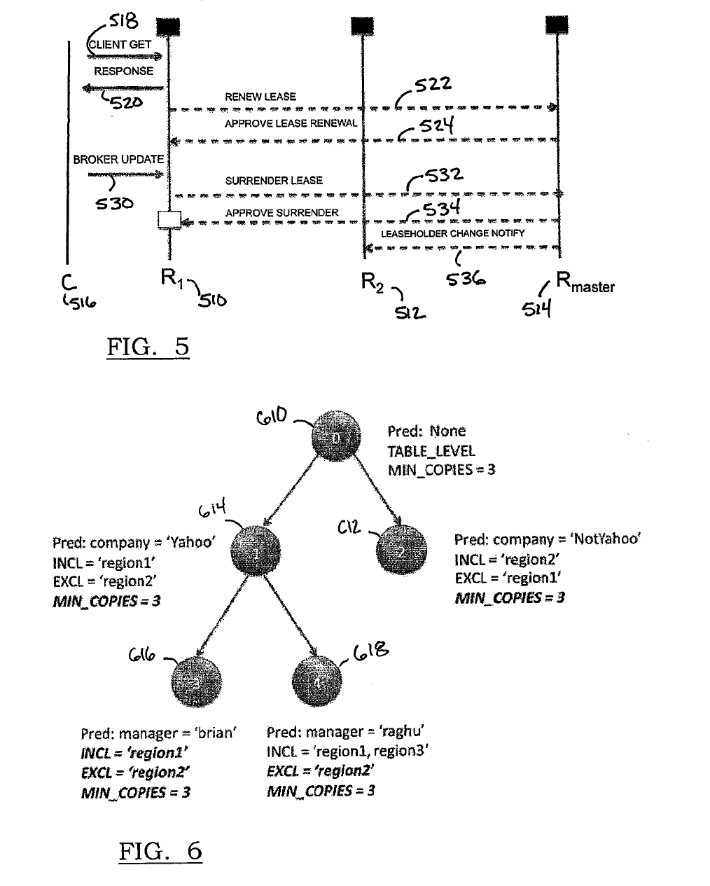

One method for lease renewal and lease surrender is provided in FIG. 5. The method for lease renewal is discussed below.

If a read for the record at R1 510 is requested after the lease has expired as denoted by line 518, it indicates that the user session is still in play. R1 510 responds to the client 516 as denoted by line 520. R1 510, then, sends a message to the record master 514 trying to renew the lease, as denoted by line 522.

If the lease renewal request is denied by the record master 514, replica R1 510 will purge the copy of the record it has and replace it with a stub. Otherwise, the record master 514 renews the lease as denoted by line 524. If constraints never change once they are created, R1 510 could perform the lease renewal unilaterally.

As noted, FIG. 5 also includes a method for lease surrender which is described below. If an update for the record over the broker, after the lease has expired as denoted by line 530, it may be assumed that the user session is no longer active at this replica and hence the cost of processing updates should not be incurred. As such, R1 510 may send a message to the record master 514 trying to surrender the lease, as denoted by line 532.

The record master 514 makes sure no constraints will be violated if the record is removed from R1 510, such as R1 510 being in the INCL_LIST or the number of copies falling below MIN_COPIES. If no constraints are violated, the record master 514 approves the surrender as denoted by line 534 and removes R1 from the replica list. In addition, the record master 514 publishes a message to all other regions notifying them of this change, as denoted by line 536. According to this method, reads at R1 510 will get the freshest data. The copy in R1 510 can also count towards the number of copies needed for constraint satisfaction.

However, since a fixed expiry value is used, it is not known how the expiry value that compares to the length of the user session. If the expiry value is too long, the record will be held longer than necessary. If the lease period is too short, the system will have to keep renewing the lease thus increasing the system load.

In method described above, a lease was acquired on a record whenever there is a forwarded read. Now, assume 3 replicas—R1 and R2, which are in the same metropolitan area, and R3, which is halfway across the world. Consider two scenarios. In the first scenario, there is a read for a record at R1, which has just a stub. The closest replica that has a copy of this record is in R2, so the read gets forwarded to R2. In the second scenario, there is again a read for the record at R1, which has just a stub. However, this time the closest replica that has a copy of this record is at R3, so the read gets forwarded to R3. In the first scenario, since the cost of forwarding from R1 to R2 is not high, it might be ok to not acquire a lease on the record and thus pay a small price in terms of latency due to the repeated forwarded reads. In the second scenario, it makes sense to acquire a copy of the record reads need not be forwarded all the way to R3. Thus, the cost in terms of latency to forward a read from replica X to replica Y can be determined and based on that determination the system can decide whether a lease is acquired or not. Another aspect is that since all replicas are aware of the constraints, before making a lease acquisition or surrender request, a replica can check to make sure that making that request does not violate any constraints and only then do so, thus avoiding unnecessary message traffic.

In another aspect of the system, lease-based selective replication can be combined with constraint enforcement. Constraint enforcement can be combined with lease-based selective replication such that on an insert, based on the constraint match the initial replica set is chosen. If there are reads at replicas that do not have a copy, they acquire a lease on the record when required.

Further, leasing can be performed based on aggregate statistics. In a given interval of time, statistics are collected on how many reads get forwarded from a given replica to each of the other replicas. Based on knowing the inter-replica latency, avg. latency can be computed at a replica for an interval. The system can determine if the latency is above or below the Service Level Agreements (SLA) promised to customers. If the latency is better than the SLA, the system can continue making the forwarded reads. If the latency is worse than the SLA, the system then needs to start acquiring leases on the records. In this instance, bandwidth is reduced until the latency gets back below the SLA.

At the other end of the spectrum, is a policy where at every replica the size of the local reads and global updates for each record are maintained. If the ratio of the local reads to global updates is greater than some pre-determined threshold, a copy of the record is stored at the replica and if it is less, the record is replaced by a stub.

Maintaining the update sizes is easy. A counter can be stored in the record itself. Every time, the record is updated, the counter is updated as well. Maintaining the read sizes is harder. Storing the read counter inside the record and updating that on every read does not work as that would end up causing a write on every read. This means the read counters would need to be stored in memory. Given the potentially tens of billions of records in a table, storing these statistics in memory could become challenging.

Constraints are needed for applications to have fine-grained control over how record-level replication is done. However, a constraint-based replication scheme is static and cannot cope with dynamic record access patterns. A replication policy based on leasing adds this dynamism to constraint enforcement. In experiments, a combined constraints and leasing policy does well in balancing the tradeoff between bandwidth consumption and latency.

A lease-based replication scheme is adaptive in the sense that it is sensitive to access patterns, but it does not depend on the collection of statistics about reads and writes for the record. However, some form of limited statistics will be needed to answer questions like how long should the lease be or when should a lease be acquired on a record rather than just forwarding requests elsewhere. As discussed above, constraints can be used with leases to ensure data integrity, however, it is also understood that constraints can be utilized independent of a leasing scenario. Constraints include an optional predicate and a set of properties, which together define the replication semantics for the records that match the given predicate. If the predicate is absent, the constraint is assumed to apply to all the records of the given table. Table 1 gives the grammar that is used to express constraints.

The replication behavior is defined by setting certain properties, which include:
MIN COPIES: The minimum number of copies of the record to keep around to satisfy the application's fault tolerance requirements.
INCL_LIST: A comma-separated list of replicas at which a copy of the record has to be kept.
EXCL_LIST: A comma-separated list of replicas where a copy of the record should not be kept.

To enable easy reconstruction of a tablet after it fails, replicas that hold a full copy of a tablet are distinguished from those that do not hold a full copy. In that case, the application may specify two separate minimum bounds, MIN FULL_COPIES and MIN PARTIAL COPIES.

Some example constraints may include:

```
IF
    TABLE_NAME = “Employee”
THEN
    SET ‘MIN_COPIES’ = 2
CONSTRAINT _PRI = 0
```

This is a table level constraint, for example, it applies to all records of the Employee table and may be stored in the table header information. The constraint specifies that each record must have 2 copies at the least. The other properties, INCL_LIST and EXCL_LIST are not specified (e.g. NULL) in this example. This constraint is of the lowest priority in that any other constraint defined on this table will supersede this constraint.

```
IF
    TABLE_NAME = ‘Employee’ AND
    FIELD_STR(‘manager’) = ‘brian’
THEN
    SET ‘MIN_COPIES’ = 3 AND
    SET ‘REPLICA_INCL_LIST’ = ‘replica1’ AND
    SET ‘REPLICA_EXCL_LIST’ = ‘replica3’
```

This constraint applies to all records of the Employee table with a field called ‘manager’ whose value matches ‘brian’.

TABLE 1
constraint: = = “IF” condition “THEN” property constraint_priority
condition :== { (table_specifier [“AND” predicate]) |
(predicate “AND” table_specifier [(“AND” | “OR”) predicate]) }
constraint_priority :== “CONSTRAINT_PRI” “=” integer_literal
table_specifier :== “TABLE_NAME” “=” table_name
table_name :== string_literal
property: == “SET” parameter “=” value [“AND” property]
parameter: = string_literal
value :== string_literal | integer_literal
string_literal: = = a single quoted string
predicate : = = expression
expression :== term [ {“AND” | “OR” } term ... ]
term: = = compare_clause | group
group :== “(“ expression ”)” | “NOT” expression
compare_clause :== var_op_clause | var_null_clause |
var_regexp_clause
var_op_clause :== {field | value} op {field | value}
op :== “<” | “<=” | “=” | “==” | “!=” | “>” | “>=”
var_null_clause :== field “IS” [ “NOT” ] “NULL”
var_regexp_clause : = = field_str “REGEXP” string_literal
value :== string_literal | integer_literal
string_literal: = = a single quoted string
field: = = field_int | field_str
field_int : = = “field_int(“ string_literal ”)”
field_str : = = “field_str(“ string_literal ”)”

For a constraint to be deemed valid, it must satisfy certain properties. For example, let R be the set of all replicas and let mc(C) be the minimum copies set by constraint C. Let ind(C) and excl(C) be the inclusion and exclusion lists respectively. Then, a constraint is valid if:

1 <= mc(C) <= IRI
incl(C) ∩; R
excl(C) C R
incl(C) ∩ excl(C) = Φ
mc(C) < = | RI − [excl(C) |

Records can potentially match predicates in more than one constraint. This can be a problem, especially, if those constraints set different values for the same property. One example is provided below.

```
IF
    TABLE_NAME = ‘Employee’ AND
    FIELD_STR(‘manager’) = ‘brian’
THEN
    SET ‘MIN_COPIES’ = 3 AND
    SET ‘REPLICA_INel_LIST’ = ‘replica1’ AND
    SET ‘REPLICA_EXCL_LIST’ = ‘replica2’
CONSTRAINT_PRJ = 1
IF
    TABLE_NAME = ‘Employee’ AND
    FIELD_STR(‘name’) = ‘sudarsh’
THEN
    SET ‘MIN_COPIES’ = 2 AND
    SET ‘REPLICA_INCl_LIST’ = ‘replica2’ AND
    SET ‘REPLICA_EXCl_LIST’ = ‘replica1’
CONSTRAINT _PRI = 2
```

In the example above, if there is an Employee with name ‘sudarsh’ and manager ‘brian’, his record is going to match the predicate in both constraints. This can be a problem because the constraints have opposite policies on the replicas at which the record should and should not be stored. There are a few strategies possible to resolve such conflicts, each with its own set of tradeoffs.

Merging the constraints provides a conservative technique for resolving the conflict. If MIN_COPIES is in conflict, merging the constraints would result in the larger value. If the INCL_LIST is in conflict, the union of the INCL_LISTs would be taken from the conflicting constraints. For example, if the INCL_LIST for the first constraint is “region1,region2” and for the second is “region2,region3”, the INCL_LIST for a record that matches both constraints would be “region1,region2,region3”. The same applies for EXCL_LISTs.

The issue with such an approach is that merging constraints can result in ambiguities such as the same replica ending up in both the EXCL_LIST and INCL_LIST. For example, the INCL_LIST for the first constraint is “region1” and EXCL_LIST is “region2”. The INCL_LIST for the second constraint is “region2” and EXCL_LIST is “region1”. When constraints are merged, both the INCL_LIST and EXCL_LIST would end up being “region1,region2”, which is something that can clearly not be satisfied. Since the set of constraints that a record matches is typically known only at run-time, it may not be easy to deal with such conflicts when they arise.

TABLE 2

CONSTRAINT RULE 0
IF

TABLE_NAME = ‘Employee’

THEN

SET MIN_COPIES = 3 AND
SET CONSTRAINT _ID = 0

CONSTRAINT RULE 1
IF

TABLE_NAME = ‘Employee’ AND
field_str(‘company’) = ‘Yahoo’

THEN

SET INCL_LIST = ‘region1’ AND
SET EXCL_LIST = ‘region2’ AND
SET CONSTRAINT_ID = 1 AND
SET PARENT_CONSTRAINT_ID = 0

CONSTRAINT RULE 2
IF

TABLE_NAME = ‘Employee’ AND
field_str(‘company’) = ‘NotYahoo’

THEN

SET INCL_LIST = ‘region2’
SET EXCL_LIST = ‘region1’
SET CONSTRAINT_ID = 2 AND
SET PARENT_CONSTRAINT_ID = 0

CONSTRAINT RULE 3
IF

TABLE_NAME = ‘Employee’ AND
field_str(‘manager’) = ‘brian’

THEN

SET CONSTRAINT_ID = 3 AND
SET PARENT_CONSTRAINT_ID = 1

CONSTRAINT RULE 4
IF

TABLE_NAME = ‘Employee’ AND
field_str(‘manager’) = ‘raghu’

THEN

SET INCL_LIST = ‘region1, region3’
SET CONSTRAINT _ID = 4 AND
SET PARENT_CONSTRAINT_ID = 1

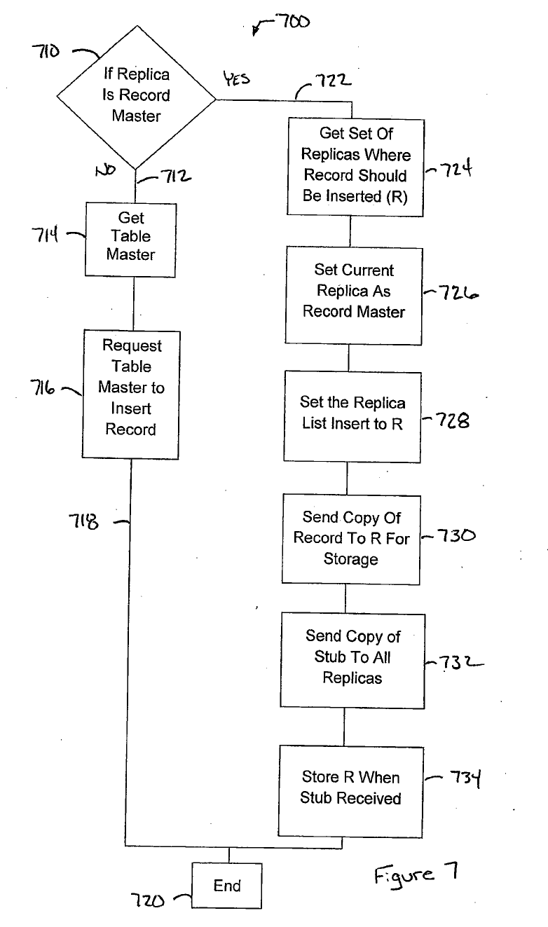

In FIG. 6, the constraints tree corresponding to a set of constraints that are identified in Table 2. Properties that are inherited at each node are in bold italics. The constraint properties of Node Zero 610 are set by Constraint Rule 0 (Table 2). This sets the MIN_COPIES property to 3, which is then inherited by each of the other Nodes 612, 614, 616, and 618. The lines between each Node indicate an inheritance link. The inheritance links are defined by the CONSTRAINT_ID and PARENT_CONSTRAINT_ID properties. While it can be seen that Node Two 612 and Node One 614 directly inherit from Node Zero 610, Node Three 616 and Node Four 618 also inherit non-defined properties from Node Zero 610, due to their link to Node One 614. In addition, Node Three 616 and Node Four 618 also inherit non-defined properties from Node One 614. However, the properties of nodes lower on the tree, e.g. 614, would take precedence over higher nodes, e.g. 610.

Another strategy is to associate priorities associated with each constraint. If a record matches the predicate in more than one constraint, the constraint with the highest priority. In this scenario, no two constraints have the same priority. Another issue is whether a constraint that is missing a given property can inherit it from other constraints.

One strategy is to define the constraints in such a way that there is a containment relationship between them. Each constraint would be associated with a node in a tree. Properties can be inherited from other constraints based on the positions of the constraints in the tree.

### Algorithm 1

### Property Inheritance: Tree

Require: A record and the set of all constraints.
Return: The properties (mc, incl and excl) for the input record.

For a given constraint C, let pri(C) refer to the constraint priority. let Pc.value refer to the value of property P at constraint node C.

If the record matches the predicate of k different constraints c1 to ck, then:

```
    1: Choose c, from the set {c1 ... ck}, such that pri(ci) =
    max{ pri(c1, pri(c2)
    ... pri(ck)}
    2: mc = mc(c1), if mc(c1, mc) is not null
        getLowestAncestor(c1, mc), otherwise,
        where mc is the min-copies property.
    3: The same rule applies for the incl and excl properties as well.
Function - getLowestAncestor
Require: node, a node in the constraints tree
P, a property such as min-copies
Return: value of property P
    1: if root does not define property P
        Pᵣₒₒₜ.value = null
    2: while node != root
    3: if node defines property P
        return P_{node.}value
    4: else
        node = Parent(node)
    5: end while
    6: return P_{root.}value
```

FIG. 6 gives an example of the inheritance scheme described in Algorithm 1. The advantage of such a strategy is that, since the structure of the constraints tree is known at compile-time, any conflicts can be ascertained (such as those between MIN_COPIES and EXCL_LIST) would arise if property inheritance evaluated along the path from the root to a leaf node. If conflicts do arise, the user can be alerted to fix them and the constraints are submitted to the datastore only if the compiler deems them to be conflict-free.

The constraints tree approach, though effective in preventing conflicts that are only discoverable at run-time, is harder to understand and explain. Another scheme is to have no hierarchy at all, as described in Algorithm 2. In Algorithm 2, there is only limited inheritance of properties. For example, there is an optional, default table-level constraint. If a constraint is missing some property that is set by the table level constraint, the table-level property is used.

### Algorithm 2

### Property Inheritance: No Hierarchy

Require: A record and the set of all constraints.
Return: The properties (mc, incl and excl) for a given record.
For a given constraint C, let pri(C) refer to the constraint priority. Let cdefault be the default, table-level constraint.

If a record matches the predicate of k different constraints c1 to ck, then:

```
1: Choose c, from the set {c1 ... ck}, such that pri(ci) = max{ pri(c1),
pri(c2) ... pri(ck)}
2: mc = mc(ci), if mc(ci) is not null
            mc(cdefault), otherwise,
    where mc is the min-copies property.
3: The same rule applies for the inel and excl properties as well.
```

During the time of table creation, the table owner defines up the constraint specification. The specification is compiled using a utility, which parses the constraints and does a compile-time validation. If there are any errors, the user is given feedback and is expected to fix them.

If the constraints are valid, the utility will load these constraints into a table. Through the normal replication process, these constraints will propagate to all the replicas. Propagation is necessary because eventually records in a table may get mastered at different replicas and each of them should be capable of enforcing the constraints.

Changing constraints after the table has been created and populated with data was considered however, constraint violations could be an issue. For example a record that is stored at a replica that is now in the EXCL_LIST. Constraint violations could be proactively fixed which would require full table scans. Alternatively, constraint violations could be fixed on-demand when a record is accessed.

One challenge is enforcing constraints. Once the constraints have been inserted into the datastore, they get enforced when records, from the tables on which the constraints have been expressed, get read or written. One useful concept to understand is a stub. A record in a table contains data as well as meta-data such as the record master and the list of replicas at which the record is stored. A record that does not have data fields, but just the meta-data in header fields, is called a stub. Through selective replication, if a record is not stored at a replica, that replica must still store a stub. This is because the stub provides the information as to where the system can locate the record, if a read request is received.

TABLE 3

| Field | Description |
|---|---|
| Per Record | |
| isStub | Boolean, indicating whether record is a full |
| | record or a stub. |
| recordMaster | Replica where record is mastered at and to |
| | where updates have to be forwarded to. |
| replicaList | List of replicas that have a copy of the |
| | record |
| Per Table | |
| tableMaster | Replica where the table is mastered at and |
| | to where inserts have to be forwarded to. |

Table 3 shows the metadata that can stored in header fields along with the data in each record, as well as per table. A read request at a replica that only contains a stub, will cause that request to get forwarded to any of the available replicas in the replica list for the given record.

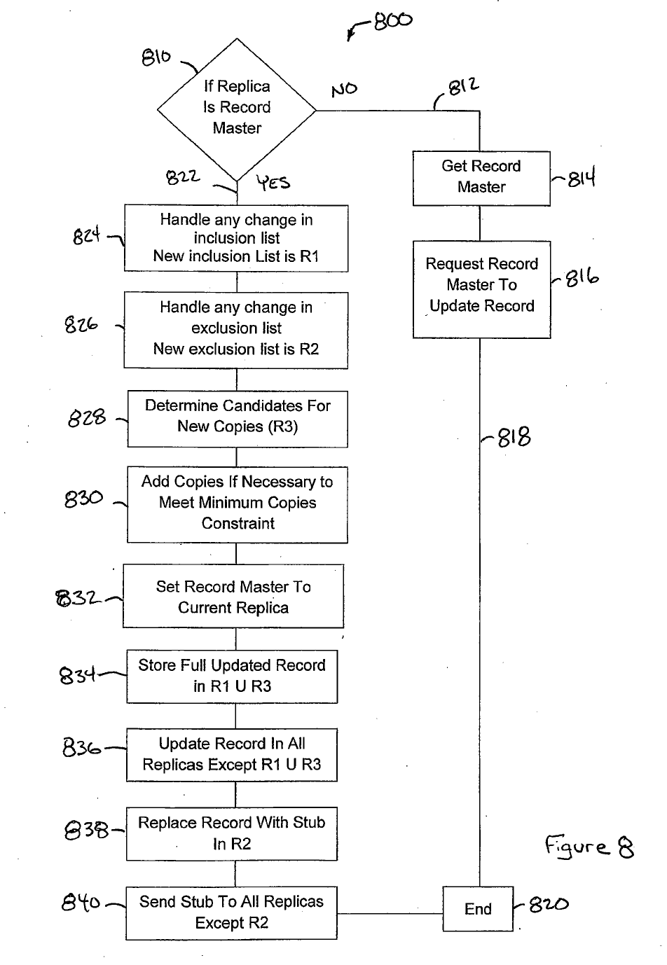

One method 700 to enforce constraints for a record insert is provided in FIG. 7. In block 710, the system determines if the replica that received the insert is the record master. If the replica is not the record master, the method follows line 712 to block 714. In block 714 the system determines the table master. Then, the request is made to the table master to insert the record, as denoted by block 716. The method then follows line 718 and ends in block 720. Referring again to block 710, if the replica is the record master then the method follows line 722 to block 724. In block 724, the system retrieves the set of replicas where the record should be inserted, for example, from the include list which is denoted as R. In block 726, the current replica is set as the record master. In block 728, the replica list to which the record is to be inserted is set to R. In block 730, a copy of the record is sent to replica list R for storage. In block 732 a stub of the record is sent to all replicas. In block 734, when the stub is received at the replicas R, the replicas store the record. The method ends in block 720.

### Algorithm 3

### Constraint Enforcement: Insert

Let there be an insert request for a record with key k and value v into table T at replica X. let M be the metadata that is stored along with each record, as described by Table 3.

Let R represent a replica set and R′ it's complement, For example, R′ includes all replicas except the ones in R.

```
X.insert_record(T,k,v)
1: if X.get_table_master(T) = X
    X.local_insert(T,k,v)
2: else
    X.get_{—} table_master(T).insert_record(T,k,v)
X.local_insert(T, k, v)
1: R <- X.choose_replicas(T,k,v)
2: M.recordMaster <- X, M.replicaList <- R
3: foreach I in R, do
    I.store(T,k,v M)
4: foreach I in R ∪ R′, do
    I.store(T, k,null, M)
```

get_table_master( ) returns the replica the table is mastered at. choose_replicas( ) returns a set of replicas where the record should be inserted, based on the constraint the record matches against.
store( ) inserts the key, metadata and value if present, into the given table. A replica will process a store(T,k,v,M) message only if it also receives a store(T,k,null,M) message. The for loop in Steps 3 and 4 is executed atomically.

Algorithm 3 describes how constraint enforcement is done on a record insert. Something to note in the Algorithm 3 above, is that store (T,k,null,M) or insert stub, is sent to all replicas and not just to the ones that did not get the full record. Had store (T,k,null,M) been called only on R′ and the master crashed after calling store(T,k,v,M) on R and before store(T,k,null,M) can be called on R′, the two sets of replicas R and R′ would become inconsistent: one set would have the full record and the other set will have no knowledge about the record. Hence, store(T,k,null,M) gets sent to R U R′. A replica that got a store(T,k,v,M) will ignore it until it also got a store(T,k,null,M) message.

Accordingly, the message broker can provide guaranteed delivery. During a network partition, it is possible that replicas in R got the store(T,k,null,M) message and replicas in R′ did not. However, this still meets the goal of eventual consistency, since once the partition goes away, the queued-up store (T,k,null,M) messages meant for R′ will get delivered.

It is possible that the server where the insert originated is in the EXCL_LIST. Normally, after the insert gets applied at table master, the record is also written at the replica that originated the insert, which is designated the record master. However, in the case where the would-be record master is in the EXCL_LIST, the table master becomes the record master. In case the table master goes down and a new master is chosen, the new master has to be a replica that is not in the EXCL_LISTs of any of the constraints defined on that table.

It is also important to update existing records. Consider the case where a user updates his locale from U.S. to U.K. It is possible for the U.S. and U.K. records to have different constraints. This means that MIN COPIES could increase or decrease and there can be additions or deletions to the INCL_LIST and EXCL_LIST. Algorithm 4. describes how constraint enforcement is done on a record update. Stubs do not need to be updated on every write. However, they have to be updated every time the replica list changes—this is so that a replica that has a stub knows whom to forward read and write requests to.

One method 800 to enforce constraints for a record update is provided in FIG. 8. In block 810, the system determines if the replica receiving the update is the record master. If the replica receiving the update is not the record master, the method follows line 812 to block 814. In block 814, the system gets the record master. In block 816, a request is sent to the record master to update the record. The method then follows line 818 and ends in block 820. Referring again to block 810, if the replica receiving the update is the record master, the method follows line 822 to block 824. In block 824, changes in the inclusion list are handled and a new inclusion list is generated which is designated as R1. In block 826, any changes to the exclusion list are handled and a new exclusion list is generated. The exclusion list is designated as R2. In block 828, candidates for new copies are determined and are designated as R3. Copies are added to replicas in R3 if necessary to meet the minimum copy constraint. In block 832 the current replica is set to record master. In block 834, a full updated record is stored in replicas R1 union R3. Then records are updated in all replicas except R1 union R3, as denoted by block 836. In block 838, records in replicas R2 are replaced with stubs. Then, in block 840, stubs are sent to all replicas except R2. A method then ends in block 820.

### Algorithm 4

### Constraint Enforcement: Update

Let there be an update request for a record with key k and value v in table T at replica X. Please refer to Algorithm 3. for some of the convention that is reused here. Cold and Cnew, refer to the constraints the record matches against, before and after the update. The MIN_COPIES, INCL_LIST and EXCL_LIST of a constraint C are represented as C.mc, C.inel and c.exct for sake of brevity.

Let v refer to the update to the record, while v* represent the full record after the update. For e.g. if the record being updated is “age=10#gender=male” and the update is “aqe=12”, then v would be “age=12” and v* would be “age=12#gender=male”.

```
    X.update_record(T,k,v)
        1: If X.get_record_master(T,k) = X
            X.local_update(T,k,v)
        2: else
            X.get_record_master(T,k).update_record(T,k,v)
    X.local_update(T,k,v)
        1: R <- M.replicaList, RI <-φ, R2 <-φ, R3 <- φ
        2: NumCopies <- Cold.mc
        3: // Handle any change in inclusion list
            3.1: RI <- Cnew.incl − Cold.incl
            3.2: R <- R ∪ R1
            3.3: NumCopies <- NumCopies + |R1|
        4: // Handle any change in exclusion list
            4.1: R2 <- Cnew.exel − Cold.exel
            4.2: R <- R − R2
            4.3: NumCopies <- NumCopies − |R2|
        5: If NumCopies < Cnew.mc
            5.1: Choose R3 from set of available replicas such that
R3 ∩ R = φ and R3 ∩ Cnew.excl = φ and |R3| =
Cnew.mc − NumCopies
            5.2: R <- R∪ R3
            5.3: NumCopies <- NumCopies + |R3|
        6: M.recordMaster <- X, M.replicalist <- R,
        7: foreach I in R1 ∪ R3
            I.store(T,k,v*,M)
        8: foreach I in R − R1 ∪ R3
            I.update(T,k,v,M)
        9: foreach I in R2
            I .purge_record(T,k,M)
        10: foreach I in (R ∪ R′) − R2
            I.u pdate(T,k,null,M)
```

get_record_master(T,k), gets the master for record k in Table T. purge_record(T,k,M), replaces record k in Table T with a stub with metadata M. update( ) updates the metadata in a record with key k and optionally the value, if present. The for loops in Steps 7, 8, 9 and 10 are executed atomically.

There are two aspects to the failure handling: (1) How are failures detected and failure information propagated to all replicas and (2) After detection of failure, what is done when a constraint violation is discovered. One way of detecting failures is to have an external monitor process that periodically pings servers in each replica to make sure that they are up. Another approach is for replicas to infer about failures of other replicas based on how requests get forwarded. This is described in Algorithm 5. In essence, replicas that process a forwarded read check to see if the node making the request is in the replica list for record k or not. If it is, the reason for the request forwarding is likely to be a failure. It is possible that there was some temporary network glitch and hence the request at replica X timed out. This might lead to false failure detections at the replica where the request gets forwarded. Thresholding can be used to reduce unnecessary copy creation due to false positives.

### Algorithm 5

### Failure Inference

Let there be a read request for record k from table T at replica X. The node requesting the read is the origin, which can either be a client or another DHT node. r.M represents the metadata in a record r, while r.v represents the data value.

```
X. read(T, k,origin)
    1: record r = X.fetch_record(T,k)
    2: If call in Step 1 timed out
        return X.c1osestPeer(X).read(T,k,X)
    3: else if r.M.isStub == true
        Y = X.getReplicaFromList(r.M.replicaList)
        return Y.read(T,k,origin)
    4: else if r.M.isStub == false
        4.1: if origin c r.M.replicaList
            X. fixConstraintViolation (T,k)
        4.2: return r.v
```

getReplicaFromList{R), returns anyone available replica from the replica set R. closestPeer(X), returns the replica that has the lowest cross-replica latency with respect to replica X.
etch_record(T,k) queries the storage node that houses the tablet containing the record (or stub) for key k and returns this record/stub. The method fixConstraintViolation( ) fixes the constraint violation by creating another copy of the record as needed after the failure has been detected.

Once failure has been detected and failure information has been disseminated to all nodes, the next time there is a read or a write request for a particular record, the system can check if the min-copies constraint has been violated and if so, create another copy (or copies, if there are multiple failures).

However, a replica that detected a constraint violation cannot just go ahead and create another copy of the record. This is because there could be multiple replicas that have simultaneously detected the constraint violation. If the replicas work independently, randomly choosing new regions to replicate the record at, will end up creating many more copies than are needed. One way to address this problem is to have a quorum-based consensus protocol among replicas. A simpler approach is that the replicas act independently in creating the new copy—but they choose the region to replicate the record at, from the same consistent ordering, which is decided deductively.

When a storage node in a replica is permanently down, the tablets that were on it will have to be recovered from other replicas. Such a recovery is hard with selective replication because no one tablet contains the complete set of records. A tablet is a horizontal partition of a table and different tablets are stored at different storage nodes within a replica. The simplest approach to tablet recovery is to make sure some of the replicas are full replicas. During tablet recovery, these replicas can be contacted and the tablet got from them.

### Algorithm 6

### Tablet Scan

```
X.tablet_scan(T, Y)
    1: foreach record k in tablet T, do
    1.1: if record k is mastered at X
    1.1.1: if Y C X.getReplicaList(k)
        Y.store(T,k,v ,M)
    1.1.2: else Y.store(T,k,v)
```

Another approach that does not require full replicas is as follows. In one example, a storage node in replica Y failed. This storage node housed tablet T. This failure information is first propagated to all the replicas. When a RECOVER_TABLET message is sent to each replica, they initiate a tablet scan to identify the records they need to send over to Y, as described in Algorithm 6. After tablet recovery, Y sends out a notification to other replicas asking them to update their replica lists for records that are now stored at Y.

The previous approach does not consider the fact that if there is a failure in a US-East Coast replica, it might be quicker to recover records from a replica in US-West Coast (if stored there), even though those records might be mastered at the Singapore replica. This represents an optimization problem that can be addressed as outlined below. The Storage Unit that failed acts as the co-coordinator for the recovery procedure, once it comes back up. During regular operation, each node collects statistics on how many records there are in each class (or, the combined size of those records). A class here represents the set of replicas that have a copy of a given record. For example, records only stored at replica 1 belong to class I, records stored at both replicas 1 and 2 belong to class II, records stored at replicas 2 and 3 belong to class III and so on.

During recovery, the co-coordinator asks all replicas for some statistics: how many classes and the record count and size of each class. Based on these statistics and an apriori cost-estimation, the coordinator determines what replicas have ownership over what classes of records (or alternatively, what decibels of a class). The costs will be derived from the inter-replica network latency. The class ownerships are communicated back to the participants. Each replica then does a scan and starts streaming out records that they are in charge of. The source determines the scheduling of data transfers from the various replicas, according to bandwidth availability at its end. The algorithm used for determining ownership is as follows. Based on the costs associated with each replica, the quota of data that each replica is allowed to send to the source is determined. The records that are unique to each replica are first counted towards this quota. Following this, for each replica r, data recovery can be prioritized from classes such that, (1) the class with the highest item count/size is picked first, or (2) the class with the lowest class membership is picked first (to save classes that offer most flexibility in terms of ownership for later).

Additional exemplary methods for implementing get and put function are provided below to provide a better understanding of one implementation of an architecture for a publisher/subscriber scenario. Other scenarios may be implemented including peer to peer replication, direct replication, or even a randomized replication strategy. However, it is understood that other methods may also be used for such functions and more or few functions may also be implemented. For get and put functions, if the router's tablet-to-storage unit mapping is incorrect (e.g. because the tablet 60 moved to a different storage unit 20), the storage unit 20 returns an error to the router 14. The router 14 could then retrieve a new mapping from the tablet controller 12, and retry its request to the new storage unit. However, this means after tablets 60 move, the tablet controller 12 may get flooded with requests for new mappings. To avoid a flood of requests, the system 10 can simply fail requests if the router's mapping is incorrect, or forward the request to a remote region. The router 14 can also periodically poll the tablet controller 12 to retrieve new mappings, although under heavy workloads the router 14 will typically discover the mapping is out-of-date quickly enough. This “router-pull” model simplifies the tablet controller 12 implementation and does not force the system 10 to assume that changes in the tablet controller's mapping are automatically reflected at all the routers 14.

In one implementation, the record-to-tablet hash function uses extensible hashing, where the first N bits of a long hash function are used. If tablets 60 are getting too large, the system 10 may simply increment N, logically doubling the number of tablets 60 (thus cutting each tablet's size in half). The actual physical tablet splits can be carried out as resources become available. The value of N is owned by the tablet controller 12 and cached at the routers 14.

Referring again to FIG. 1, the transaction bank 22 has the responsibility for propagating updates made to one record to all of the other replicas of that record, both within a farm and across farms. The transaction bank 22 is an active part of the consistency protocol.

Applications, which use the system 10 to store data, expect that updates written to individual records will be applied in a consistent order at all replicas. Because the system 10 uses asynchronous replication, updates will not be seen immediately everywhere, but each record retrieved by a get operation will reflect a consistent version of the record.

As such, the system 10 achieves per-record, eventual consistency without sacrificing fast writes in the common case. Because of extensible hashing, records 50 are scattered essentially randomly into tablets 60. The result is that a given tablet typically consists of different sets of records whose writes usually come from different regions. For example, some records are frequently written in the east coast farm, while other records are frequently written in the west coast farm, and yet other records are frequently written in the European farm. The system's goal is that writes to a record succeed quickly in the region where the record is frequently written.

To establish quick updates the system 10 implements two principles: 1) the master region of a record is stored in the record itself, and updated like any other field, and 2) record updates are “committed” by publishing the update to the transaction bank 22. The first aspect, that the master region is stored in the record 50, seems straightforward, but this simple idea provides surprising power. In particular, the system 10 does not need a separate mechanism, such as a lock server, lease server or master directory, to track who is the master of a data item. Moreover, changing the master, a process requiring global coordination, is no more complicated than writing an update to the record 50. The master serializes updates to a record 50, assigning each a sequence number. This sequence number can also be used to identify updates that have already been applied and avoid applying them twice.

Secondly, updates may be committed by publishing the update to the transaction bank 22. There is a transaction bank broker in each datacenter that has a farm; each broker consists of multiple machines for redundancy and scalability. Committing an update requires only a fast, local network communication from a storage unit 20 to a broker machine. Thus, writes in the master region (the common case) do not require cross-region communication, and are low latency.

The transaction bank 22 can provide the following features even in the presence of single machine, and some multiple machine, failures:
An update, once accepted as published by the transaction bank 22, is guaranteed to be delivered to all live subscribers.
An update is available for re-delivery to any subscriber until that subscriber confirms the update has been consumed.
Updates published in one region on a given topic will be delivered to all subscribers in the order they were published. Thus, there is a per-region partial ordering of messages, but not necessarily a global ordering.

These properties allow the system 10 to treat the transaction bank 22 as a reliable redo log: updates, once successfully published, can be considered committed. Per region message ordering is important, because it allows publishing a “mark” on a topic in a region. As such, remote regions can be sure, when the mark message is delivered, that all messages from that region published before the mark have been delivered. This will be useful in several aspects of the consistency protocol described below.

By pushing the complexity of a fault tolerant redo log into the transaction bank 22 the system 10 can easily recover from storage unit failures, since the system 10 does not need to preserve any logs local to the storage unit 20. In fact, the storage unit 20 becomes completely expendable; it is possible for a storage unit 20 to permanently and unrecoverably fail and for the system 10 to recover simply by bringing up a new storage unit and populating it with tablets copied from other farms, or by reassigning those tablets to existing, live storage units 20.

However, the consistency scheme allows the transaction bank 22 to be a reliable keeper of the redo log. However, any implementation that provides the above guarantees can be used, although custom implementations may be desirable for performance and manageability reasons. One custom implementation may use multi-server replication within a given broker. The result is that data updates are always stored on at least two different disks; both when the updates are being transmitted by the transaction bank 22 and after the updates have been written by storage units 20 in multiple regions. The system 10 could increase the number of replicas in a broker to achieve higher reliability if needed.

In the implementation described above, there may be a defined topic for each tablet 60. Thus, all of the updates to records 50 in a given tablet are propagated on the same topic. Storage units 20 in each farm subscribe to the topics for the tablets 60 they currently hold, and thereby receive all remote updates for their tablets 60. The system 10 could alternatively be implemented with a separate topic per record 50 (effectively a separate redo log per record) but this would increase the number of topics managed by the transaction bank 22 by several orders of magnitude. Moreover, there is no harm in interleaving the updates to multiple records in the same topic.

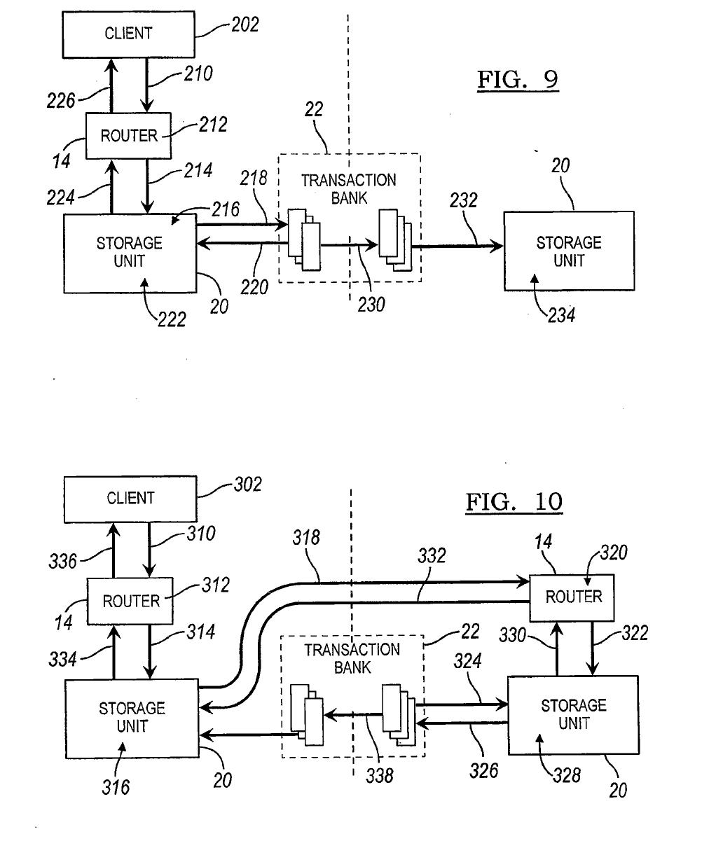

Unlike the get operation, the put and remove operations are update operations. The sequence of messages is shown in FIG. 9. The sequence shown considers a put operation to record rᵢ that is initiated in the farm that is the current master of rᵢ. First, the client 202 sends a message containing the record key and the desired updates to a router 14, as denoted by line 21. As with the get operation, the router 14 hashes the key to determine the tablet and looks up the storage unit 20 currently holding that tablet as denoted by reference numeral 212. Then, as denoted by line 214, the router 14 forwards the write to the storage unit 20. The storage unit 20 reads a special “master” field out of its current copy of the record to determine which region is the master, as denoted by reference number 216. In this case, the storage unit 20 sees that it is in the master farm and can apply the update. The storage unit 20 reads the current sequence number out of the record and increments it. The storage unit 20 then publishes the update and new sequence number to the local transaction bank broker, as denoted by line 218. Upon receiving confirmation of the publish, as denoted by line 220, the storage unit 20, considers the update committed. The storage unit 20 writes the update to its local disk, as denoted by reference numeral 222. The storage unit 20 returns success to the router 14, which in turn returns success to the client 202, denoted by lines 224 and 226, respectively.

Asynchronously, the transaction bank 22 propagates the update and associated sequence number to all of the remote farms, as denoted by line 230. In each farm, the storage units 20 receive the update, as denoted by line 232, and apply it to their local copy of the record, as denoted by reference number 234. The sequence number allows the storage unit 20 to verify that it is applying updates to the record in the same order as the master, guaranteeing that the global ordering of updates to the record is consistent. After applying the record, the storage unit 20 consumes the update, signaling the local broker that it is acceptable to purge the update from its log if desired.

Now consider a put that occurs in a non-master region. An exemplary sequence of messages is shown in FIG. 10. The client 302 sends the record key and requested update to a router 14 (as denoted by line 310), which hashes the record key (as denoted by numeral 312) and forwards the update to the appropriate storage unit 20 (as denoted by line 314). As before, the storage unit 20 reads its local copy of the record (as denoted by numeral 316), but this time it finds that it is not in the master region. The storage unit 20 forwards the update to a router 14 in the master region as denoted by line 318. All the routers 14 may be identified by a per-farm virtual IP, which allows anyone (clients, remote storage units, etc.) to contact a router 14 in an appropriate farm without knowing the actual IP of the router 14. The process in the master region proceeds as described above, with the router hashing the record key (320) and forwarding the update to the storage unit 20 (322). Then, the storage unit 20 publishes the update 324, receives a success message (326), writes the update to a local disk (328), and returns success to the router 14 (330). This time, however, the success message is returned to the initiating (non-master) storage unit 20 along with a new copy of the record, as denoted by line 332. The storage unit 20 updates its copy of the record based on the new record provided from the master region, which then returns success to the router 14 and on to the client 302, as denoted by lines 334 and 336, respectively.

Further, the transaction bank 22 asynchronously propagates the update to all of the remote farms, as denoted by line 338. As such, the transaction bank eventually delivers the update and sequence number to the initiating (non-master) storage unit 20.

The effect of this process is that regardless of where an update is initiated, it is processed by the storage unit 20 in the master region for that record 50. This storage unit 20 can thus serialize all writes to the record 50, assigning a sequence number and guaranteeing that all replicas of the record 50 see updates in the same order.

The remove operation is just a special case of put; it is a write that deletes the record 50 rather than updating it and is processed in the same way as put. Thus, deletes are applied as the last in the sequence of writes to the record 50 in all replicas.

A basic algorithm for ensuring the consistency of record writes has been described. Above, however, there are several complexities which must be addressed to complete this scheme. For example, it is sometimes necessary to change the master replica for a record. In one scenario, a user may move from Georgia to California. Then, the access pattern for that user will change from the most accesses going to the east coast datacenter to the most accesses going to the west coast datacenter. Writes for the user on the west coast will be slow until the user's record mastership moves to the west coast.

In the normal case (e.g., in the absence of failures), mastership of a record 50 changes simply by writing the name of the new master region into the record 50. This change is initiated by a storage unit 20 in a non-master region (say, “west coast”) which notices that it is receiving multiple writes for a record 50. After a threshold number of writes is reached, the storage unit 20 sends a request for the ownership to the current master (say, “east coast”). In this example, the request is just a write to the “master” field of the record 50 with the new value “west coast.” Once the “east coast” storage unit 20 commits this write, it will be propagated to all replicas like a normal write so that all regions will reliably learn of the new master. The mastership change is also sequenced properly with respect to all other writes: writes before the mastership change go to the old master, writes after the mastership change will notice that there is a new master and be forwarded appropriately (even if already forwarded to the old master). Similarly, multiple mastership changes are also sequenced; one mastership change is strictly sequenced after another at all replicas, so there is no inconsistency if farms in two different regions decide to claim mastership at the same time.

After the new master claims mastership by requesting a write to the old master, the old master returns the version of the record 50 containing the new master's identity. In this way, the new master is guaranteed to have a copy of the record 50 containing all of the updates applied by the old master (since they are sequenced before the mastership change.) Returning the new copy of a record after a forwarded write is also useful for “critical reads,” described below.

This process requires that the old master is alive, since it applies the change to the new mastership. Dealing with the case where the old master has failed is described further below. If the new master storage unit fails, the system 10 will recover in the normal way, by assigning the failed storage unit's tablets 60 to other servers in the same farm. The storage unit 20 which receives the tablet 60 and record 50 experiencing the mastership change will learn it is the master either because the change is already written to the tablet copy the storage unit 20 uses to recover, or because the storage unit 20 subscribes to the transaction bank 22 and receives the mastership update.

When a storage unit 20 fails, it can no longer apply updates to records 50 for which it is the master, which means that updates (both normal updates and mastership changes) will fail. Then, the system 10 must forcibly change the mastership of a record 50. Since the failed storage unit 20 was likely the master of many records 50, the protocol effectively changes the mastership of a large number of records 50. The approach provided is to temporarily re-assign mastership of all the records previously mastered by the storage unit 20, via a one-message-per-tablet protocol. When the storage unit 20 recovers, or the tablet 60 is reassigned to a live storage unit 20, the system 10 rescinds this temporary mastership transfer.

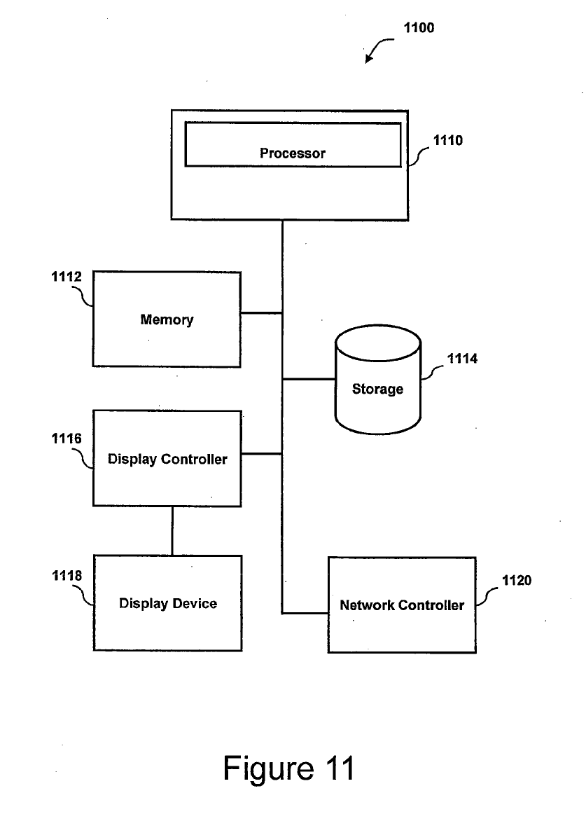

Any of the modules, servers, routers, storage units, controllers, or engines described may be implemented with one or more computer systems. If implemented in multiple computer systems the code may be distributed and interface via application programming interfaces. Further, each method may be implemented on one or more computers. One exemplary computer system is provided in FIG. 11. The computer system 1100 includes a processor 1110 for executing instructions such as those described in the methods discussed above. The instructions may be stored in a computer readable medium such as memory 1112 or a storage device 1114, for example a disk drive, CD, or DVD. The computer may include a display controller 1116 responsive to instructions to generate a textual or graphical display on a display device 1118, for example a computer monitor. In addition, the processor 1110 may communicate with a network controller 1120 to communicate data or instructions to other systems, for example other general computer systems. The network controller 1120 may communicate over Ethernet or other known protocols to distribute processing or provide remote access to information over a variety of network topologies, including local area networks, wide area networks, the internet, or other commonly used network topologies.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this application. This description is not intended to limit the scope or application of the claim in that the invention is susceptible to modification, variation and change, without departing from spirit of this application, as defined in the following claims.

We claim:

1. A system for maintaining a database with a plurality of replicas that are geographically distributed, the system comprising:
a storage unit including a plurality of tables in a first replica of the plurality of replicas, each table of the plurality of tables comprising a plurality of records; and
wherein the storage unit identifies if the record is a stub and requests a lease from a second replica designated as master for the record, the storage unit receiving a copy of the record from the second replica and storing data fields in response to the lease request.

2. The system according to claim 1, wherein the second replica determines if any constraint rules will be violated by storing data fields in the first replica

3. The system according to claim 1, wherein the lease is a permission to store the record that has a limited time.

4. The system according to claim 3, wherein storage unit requests a renewal of the lease if a read request for the record is received and the limited time has expired.

5. The system according to claim 4, wherein the storage unit purges the record and replaces the record with a stub if the renewal is denied.

6. The system according to claim 1, wherein the storage unit sends a message to the second replica offering surrender of the lease if an update is received and the limited time has expired.

7. The system according to claim 1, wherein storage unit determines the average latency for delivering a record to a client and requests a lease based on the average latency.

8. The system according to claim 7, wherein storage unit requests a lease if the average latency is above a predetermined latency.

9. The system according to claim 1, wherein the storage unit requests a lease if the ratio of local reads to global updates is above a predetermined ratio.

10. A method for maintaining a database with a plurality of replicas that are geographically distributed, the method comprising the steps of:
storing a plurality of tables in a first replica of the plurality of replicas, each table of the plurality of tables comprising a plurality of records;
identifying if the record is a stub;
requesting a lease from a second replica designated as master for the record;
receiving a copy of the record from the second replica; and
storing data fields of the record in the first replica.

11. The method according to claim 10, wherein the second replica determines if any constraint rules will be violated by storing data fields in the first replica

12. The method according to claim 10, wherein the lease is a permission to store the record that has a limited time.

13. The method according to claim 12, further comprising requesting a renewal of the lease if a read request for the record is received and the limited time has expired.

14. The method according to claim 10, further comprising sending a message to the second replica offering surrender of the lease if an update is received and the limited time has expired.

15. The method according to claim 10, further comprising determining the average latency for delivering a record to a client and requests a lease based on the average latency.

16. A computer readable medium having stored therein instructions executable by a programmed processor for maintaining a database with a plurality of replicas that are geographically distributed, the computer readable medium comprising instructions for:
storing a plurality of tables in a first replica of the plurality of replicas, each table of the plurality of tables comprising a plurality of records;
identifying if the record is a stub;
requesting a lease from a second replica designated as master for the record
receiving a copy of the record from the second replica; and
storing data fields of the record in the first replica.

17. The computer readable medium according to claim 16, wherein the second replica determines if any constraint rules will be violated by storing data fields in the first replica

18. The computer readable medium according to claim 16, wherein the lease is a permission to store the record that has a limited time.

19. The computer readable medium according to claim 18, further comprising requesting a renewal of the lease if a read request for the record is received and the limited time has expired.

20. The computer readable medium according to claim 16, further comprising sending a message to the second replica offering surrender of the lease if an update is received and the limited time has expired.

21. The computer readable medium according to claim 16, further comprising determining the average latency for delivering a record to a client and requests a lease based on the average latency.
